(19) United States
(12) Patent Application Publication
(10) Pub. No.: US 2025/0074221 A1
(43) Pub. Date: Mar. 6, 2025

(54) CHARGER AND CONTROL METHOD OF THE SAME

(71) Applicant: LG ELECTRONICS INC., Seoul (KR)

(72) Inventors: Kangsuk LEE, Seoul (KR); Hoon HUR, Seoul (KR)

(73) Assignee: LG ELECTRONICS INC., Seoul (KR)

(21) Appl. No.: 18/390,699

(22) Filed: Dec. 20, 2023

(30) Foreign Application Priority Data
Sep. 4, 2023 (KR) 10-2023-0117290

(51) Int. Cl. B60L 53/18; H02J 7/00

(52) U.S. Cl. CPC B60L 53/18; H02J 7/0042

(57) ABSTRACT

A charger according to the disclosure includes a rail body on which a plurality of rails is formed; a plurality of guides that are correspondingly and slidably arranged on the plurality of rails and configured to support a charging cable of the charger; a plurality of electromagnets correspondingly disposed on the plurality of guides; and a control unit configured to control a position of the charging cable by operation of the plurality of electromagnets.

### CROSS-REFERENCE TO RELATED APPLICATIONS

Pursuant to 35 U.S.C. § 119(a), this application claims the benefit of earlier filing date and right of priority to Korean Patent Application No. 10-2023-0117290, filed on Sep. 4, 2023, the contents of which are hereby incorporated by reference herein in its entirety.

### BACKGROUND

The present invention relates to a charger and a control method of the same.

A charger is a device used to charge a storage battery.

An example of the charger may be an electric vehicle charger that charges a vehicle such as an electric vehicle, and electrical energy is supplied to a battery of the electric vehicle by connecting a charging connector provided at an end of a charging cable to a connection inlet installed in the electric vehicle.

In order to use the charging cable, the charging cable can be used after unwinding a coiled charging cable and withdrawing the charging cable. Due to a length of a pulled-out or withdrawn charging cable, a middle portion of the charging cable may touch a floor or ground, and the portion touching the floor or ground may be damaged by repeated use, such as by being worn out or contaminated by contaminants on the floor

An example of a charging device for an electric vehicle comprises a charging body; a charging cable connected to the charging body and having a charging gun or coupler at an end; a guide frame installed at one side of the charging body and on which a rail guide is formed; first and second roller modules formed to travel along the rail guide of the guide frame; and a mounting bracket that is connected to the first and second roller modules and transported together, wherein the first and second roller modules travel on the rail guide according to a stopped position of the electric vehicle to be charged to move the position of the charging cable.

Another example of a charger is a charging facility for electric vehicles comprising a cable guide unit installed on the ceiling where electric vehicles are loaded; a vehicle charging device that charges the driving battery of the electric vehicle while moving back and forth along the cable guide; and a power management device that supplies power to the battery. The cable guide part comprises a rail that provides a path along which the running part of the vehicle charging device moves and installed on the ceiling and arranged in a straight line; and a plurality of guide rings installed to slide along the rail and configured to allow the charging cable of the vehicle charging device to be suspended at regular intervals. The vehicle charging device may comprise a charging cable having one end connected to the power management device and a plug at the other end to charge the battery; and a traveling part that is movably installed on the cable guide part and moves the charging cable.

### SUMMARY

A purpose of this disclosure is to provide a charger and a control method of the same that can minimize the force with which the user pulls the charging cable.

A purpose of this disclosure is to provide a charger and a control method of the same through which a charging cable can be reliably pull in.

A charger according to an embodiment of this disclosure comprises a rail body on which a plurality of rails is formed; a plurality of guides that are correspondingly and slidably arranged on the plurality of rails and on which the charging cable is suspended; a plurality of electromagnets correspondingly disposed on the plurality of guides; and a control unit configured to control a position of the charging cable by operation of the plurality of electromagnets.

A first guide of the plurality of guides is disposed such that an overlap area of the first guide overlaps an overlap area of an adjacent second guide with respect to a longitudinal direction of the rail body.

The guide may comprise a base; and a supporter formed at a bottom of the base and on which the charging cable is suspended.

The overlap area of the first guide corresponds to the base of the first guide, and an area of the first guide corresponding to the supporter does not overlap with an area of a supporter of the second guide.

The charger may further comprise a guide communication module disposed at each guide, and a receiving portion in which the guide communication module is accommodated may be formed inside the guide.

The charger may further comprise a flat cable disposed between the rail body and the guide and configured to supply power to the plurality of electromagnets.

The charger may further comprise a plurality of balls disposed between an upper surface of the guide and the flat cable.

The control unit may be configured to perform a cable pull-out mode by controlling the plurality of electromagnets such that the plurality of guides are moved away from each other.

The charger may comprise a main body to which a charging cable is connected.

The main body may comprise a holster providing a mount for a coupler of the charging cable; and a coupler sensor installed at the holster to detect mounting of the coupler.

The main body may further comprise a coupler holder rotatably or slidably disposed in the holster.

The pull-out mode may be initiated when the coupler sensor detects pulling out of the coupler.

The charger may comprise a coupler holder rotatably or slidably disposed in the holster.

The pull-out mode may comprise a first mode that turns on the first electromagnet and the second electromagnet among the plurality of electromagnets with the same polarity; a second mode in which the first and second electromagnets among the plurality of electromagnets are turned on with opposite polarities after the first mode.

The control unit may turn on the second and the third electromagnets among the plurality of electromagnets with the same polarity during the second mode.

In an embodiment, performing the cable pull-out mode may include performing a first mode configured to turn on in which the first and the second electromagnets among the plurality of electromagnets with are operated to have a the same polarity; and performing, after the first mode, a second mode configured to turn on in which the first and the second electromagnets among the plurality of electromagnets with are operated to have opposite polarities, after the first mode.

The control unit may be configured to operate the second and the third electromagnets to have a same polarity during the second mod.

The control unit may perform a pull-in mode by controlling the plurality of electromagnets such that the plurality of guides are moved closer to each other.

The pull-in mode may be initiated when the charging cable is disconnected from the electric vehicle.

The control unit may perform a locking mode that controls the plurality of electromagnets to keep the plurality of guides close to each other.

The control unit may generate a cable-out signal that controls a plurality of electromagnets so that the plurality of guides are moved away from each other based on detecting that the coupler of the charging cable is separated from the main body; a first cable stop signal based on detecting that the coupler of the charging cable is connected to an electric vehicle, a cable-in signal to cause operation of a plurality of electromagnets so that the plurality of guides are moved closer to each other based on detecting that the coupler of the charging cable is separated from the electric vehicle; and a second cable stop signal based on detecting that the coupler of the charging cable is mounted on the main body.

A control method of the charger according to an embodiment of this disclosure may include generating a cable-out signal that controls a plurality of electromagnets so that the plurality of guides are moved away from each other based on detecting that the coupler of the charging cable is separated from a main body of the charger; generating a first cable stop signal based on detecting that the coupler of the charging cable is connected to an electric vehicle; generating a cable-in signal to control a plurality of electromagnets so that the plurality of guides are moved closer to each other based on detecting that the coupler of the charging cable is separated from the electric vehicle; and generating a second cable stop signal based on detecting that the coupler of the charging cable is mounted on the main body.

### BRIEF DESCRIPTION OF THE DRAWINGS

FIG. 1 is a perspective view showing a charger when a charging cable is pulled in according to an embodiment of the present disclosure;

FIG. 2 is a perspective view showing the charger when the charging cable is pulled out according to an embodiment,

FIG. 3 is a view showing the configuration of the main body according to an embodiment,

FIG. 4 is a view of a holster provided in the main body according to an embodiment;

FIG. 5 is a view showing a coupler holder according to an embodiment;

FIG. 6 is a bottom view showing the bottom of the rail body according to an embodiment;

FIG. 7 is a perspective view of a guide according to an embodiment;

FIG. 8 is a partially cut away perspective view showing the rail body and guide according to an embodiment;

FIG. 9 is a view illustrating various modes of the charger according to an embodiment; and

FIG. 10 is a view showing the pull-out mode of the charger according to an embodiment.

### DETAILED DESCRIPTION OF THE EMBODIMENTS

Hereinafter, detailed embodiments will be described in detail with reference to the accompanying drawings.

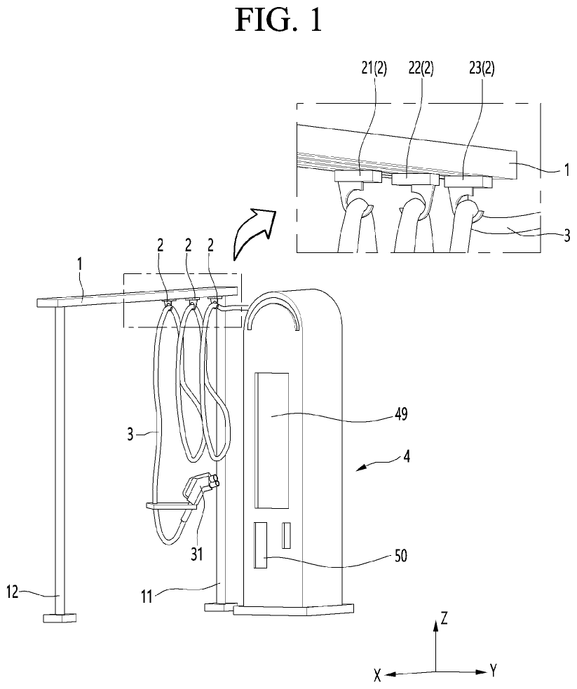

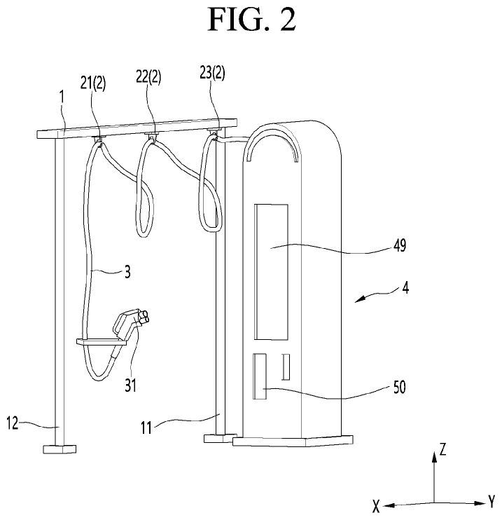

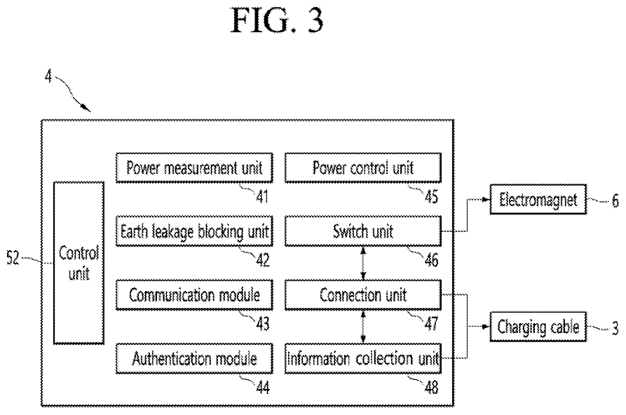

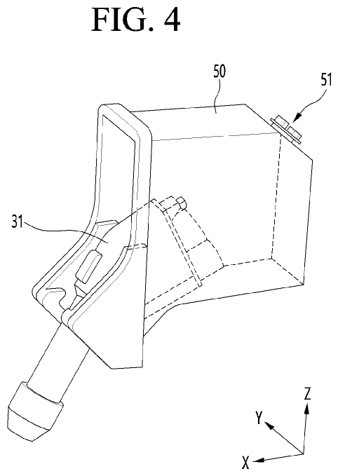

FIG. 1 is a perspective view showing a charger when a charging cable according to an embodiment is pulled in; FIG. 2 is a perspective view showing the charger when the charging cable according to an embodiment is pulled out, FIG. 3 is a view showing the configuration of the main body according to an embodiment, and FIG. 4 is a view of a holster provided in the main body according to an embodiment.

The charger may be a charging station that charges an electric vehicle.

The charger may comprise a rail body 1, a plurality of guides 2, a charging cable 3, and a main body 4.

The rail body 1 may be placed on the main body 4 or placed close to the main body 4.

The rail body 1 may be placed on a pair of posts 11 and 12 spaced apart from each other. The rail body 1 may be elongated along in the front and rear direction X, as shown in FIG. 2.

A rail on which the guide 2 slides may be formed on the rail body 1.

A plurality of guides 2 can slide along the rail body 1. A plurality of guides 2 may be disposed on the rail body 1 to slide independently of each other. The plurality of guides 2 may be spaced apart from each other in the longitudinal direction X of the rail body 1.

Each of the plurality of guides 2 may be a non-magnetic material. Each of the plurality of guides 2 may be a non-conductor.

A plurality of guides 2 may be arranged in a row on the rail body 1. A plurality of guides 2 may be disposed in a row in the longitudinal direction X of the rail body 1.

The charging cable 3 may be sequentially mounted on a plurality of guides 2. The plurality of guides 2 may be disposed to be spaced apart from each other in the longitudinal direction (X) of the rail body 1.

Each of the plurality of guides 2 may utilize a same or similar component. The number of guides 2 may be 2, 3, 4, etc. For convenience of explanation, an embodiment having 3 guides will be described below, but of course, the number of guides 2 is not limited thereto. Meanwhile, when explaining a common configuration of the plurality of guides 2, it may be referred to in the singular as a guide 2, and when referred to separately, the guides may be referred to individually as the first guide 21, the second guide 22, the third guide 23, or the like.

The plurality of guides 2 can distribute the load for mounting the charging cable 3, and allow the user to pull or push the charging cable 3 with a small force. The plurality of guides 2 can move sequentially and can be changed to various positions along the rail body 1.

As shown in FIG. 1, the plurality of guides 2 may be gathered as close as possible to the post 11 that is closer to the main body 4 among the pair of posts 11 and 12 and a coupler 31 of the charging cable 3 may be positioned close to the main body 4. In such a position, the charging cable 3 may be referred to as being pulled in.

As shown in FIG. 2, the plurality of guides 2 may be spaced apart from each other so that the coupler 31 of the charging cable 3 is positioned away from the main body 4. In such a position, the charging cable 3 may be referred to as being pulled out.

The charging cable 3 may extend from the main body 4 and may be suspended on the plurality of guides 2. One end of the charging cable 3 may be connected to the connection unit 47 (refer to FIG. 3) of the main body 4, and a coupler 31 may be provided on the other end of the charging cable 3. An example of the coupler 31 may be a rechargeable gun or coupler that a user can hold.

The charger may comprise a communication module that communicates with the electric vehicle being charged by the charging cable 3. The communication module may be a power line communication (PLC) module, or the like. A communication module may be provided in the coupler 31. The communication module placed in the coupler 31 can receive information related to charging from the electric vehicle. The communication module of the coupler 31 can communicate with the control unit 52.

The charging cable 3 can be connected to the main body 4.

The main body 4 may be a charger body, and the main body 4 may comprise a housing or case that forms the exterior of the charger.

Referring to FIG. 3, the main body 4 comprises a power measurement unit 41, an earth leakage blocking unit 42, a communication module 43, an authentication module 44, a power control unit 45, a switch unit 46, a connection unit. (47), and an information collection unit 48 may be provided.

The power measurement unit 41 may measure the power supplied to the electric vehicle through the charging cable 3.

The earth leakage blocking unit 42 may comprise a circuit that blocks earth leakage in the main body 4 or the charging cable 3.

The communication module 43 may comprise a module that communicates with a mobile terminal or server.

The authentication module 44 may authenticate the user using the charger.

The power control unit 45 may control the power of the main body 4 or the charging cable 3.

The switch unit 46 may be electrically connected to a power supply (not shown) provided to the guide 2, and the switch unit 46 may allow current to be applied to or blocked from the power supply provided to the guide 2. The switch unit 46 can allow current to be applied in the opposite direction.

The switch unit 46 may comprise a first switch capable of blocking the current applied to the power supply unit.

The switch unit 46 may comprise a second switch capable of switching the current applied to the power supply unit in the opposite direction.

The first switch and the second switch may also be disposed to be spaced apart from each other along the power system line. In some embodiments, one of the first switch or the second switch is placed in the main body 4, and the other one of the first switch or the second switch is placed in the power supply unit of the guide 2.

It is possible for the first switch and the second switch to be provided together in one switch element, and it is also possible for one switch element to apply and block current and change the direction of the current.

The charging cable 3 may be connected to the connection unit 47.

The information collection unit 48 may collect and store information on the charging cable 3.

The information of the charging cable 3 may comprise connection information of the charging cable 3, charging information, suspending information (or standby information), etc.

The connection information may be information about whether the coupler 31 of the charging cable 3 is connected to or disconnected from the electric vehicle.

The charging information may comprise information about whether the charging cable 3 is currently charging and information about a charge level of the battery of the electric vehicle.

The suspending information may comprise information such as whether the coupler 31 of the charging cable 3 is suspended on the holster 50 or separated from the holster 50.

A screen 49 (refer to FIGS. 1 and 2) may be disposed on the main body 4.

The user can check charging information through the screen 49 and input charging commands or payment information through the screen 49.

The main body 4 may comprise a holster 50 on which the coupler 31 of the charging cable 3 is mounted. The holster 50 may be a coupler holder or a charging gun holder.

A coupler sensor 51 that senses the coupler 31 may be installed in the holster 50. Examples of coupler sensors may include distance sensors, hall sensors, or the like, and may sense the presence or absence of the coupler 31. The coupler sensor 51 is not limited to the disclosure herein, and of course, one of ordinary skill will appreciate that any sensor or component capable of sensing the presence or absence of the coupler 31 may be applied.

In an embodiment in which the coupler sensor 51 is a Hall sensor, a magnet may be installed in the coupler 31, and the coupler sensor 51 may detect a magnetic field when the coupler 31 is completely mounted on the holster 50. The coupler sensor 51 may transmit the detection result to the control unit 52. The coupler sensor 51 may transmit mounting information to the control unit 52.

When the coupler 31 is completely mounted on the holster 50, the coupler sensor 51 can transmit an ON signal to the control unit 52. When the coupler 31 is separated from the holster 50, the coupler sensor 51 may transmit an OFF signal to the control unit 52.

The charger may further comprise a control unit 52 that controls the overall operation of the charger. The control unit 52 may be installed in the main body 4. An example of the control unit 52 may comprise a processor or microcomputer that controls the overall operation of the charger.

An outlet (not shown) through which the charging cable 3 extends outside the main body 4 may be formed on one side of the main body 4.

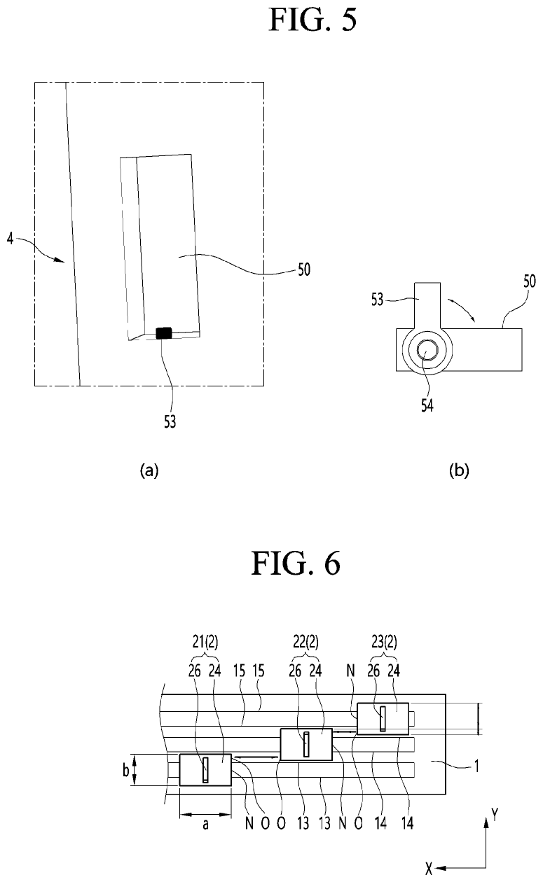

FIG. 5 is a view showing a coupler holder according to an embodiment.

The charger may comprise a coupler holder 53.

A groove formed in the coupler 31 may be configured to be seated in the coupler holder 53, and when the coupler 31 is inserted into the interior of the holster 50 and seated in the coupler holder 53, arbitrary or accidental removal of the coupler 31 may be prevented.

FIG. 5 (a) is a view showing the coupler holder 53 disposed to protrude inside the holster 50, and FIG. 5 (b) is a view showing an example of the coupler holder being rotated.

The coupler holder 53 may be placed in the holster 50 to rotate or slide.

The charger may further comprise a driving source 54 such as a motor capable of rotating the coupler holder 53.

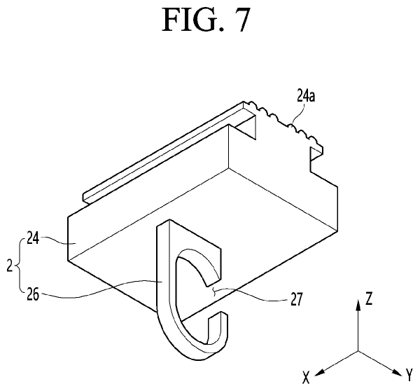

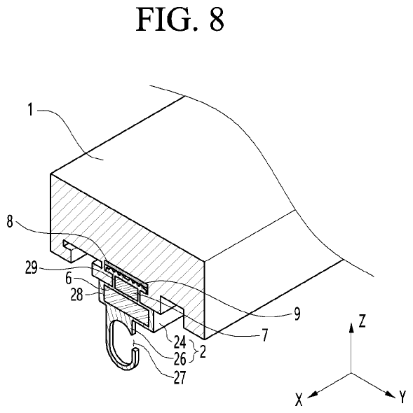

FIG. 6 is a bottom view of the rail body according to an embodiment of the present disclosure; FIG. 7 is a perspective view of a guide according to an embodiment; and FIG. 8 is a partially cut away perspective view showing the rail body and guide according to an embodiment.

The rail body 1 may comprise a beam with a space formed therein, and an opening for forming a rail may be formed in the lower plate of the beam.

The upper portion of the guide 2 can be movably accommodated in the space of the beam.

The opening of the beam may be located on the lower side of the space of the beam, and the guide 2 may be moved along the opening in the longitudinal direction of the rail body 1.

A plurality of rails 13, 14, and 15 may be formed on the rail body 1. Each of the plurality of rails 13, 14, and 15 may be formed to be long in the longitudinal direction X of the rail body 1. The plurality of rails 13, 14, and 15 may be spaced apart from each other in a direction Y perpendicular to the longitudinal direction X of the rail body 1.

The plurality of guides 2 may be disposed to slide on each of the plurality of rails 13, 14, and 15.

The plurality of rails 13, 14, and 15 may correspond 1:1 to the plurality of guides 2, and the charger may comprise a first guide 21, a second guide 22, and a third guide 23.

The plurality of rails 13, 14, and 15 comprise a first rail 13 on which the first guide 21 is slidably guided, and a second rail 14 on which the second guide 22 is slidably guided, and a third rail 15 on which the third guide 23 is slidably guided.

The upper plate of each of the plurality of guides 2 may be seated on a rail.

Each of the plurality of guides 2 may be rectangular, and the length “a” may be greater than the width “b”.

Each of the plurality of guides 2 may comprise an overlap area O and a non-overlap area N.

As shown in FIG. 6, the overlap area O may be an area that overlaps a sliding area of another adjacent guide. The overlap area O may align with another adjacent guide in the longitudinal direction X of the guide 2.

The overlap area O of the first guide 21 overlaps the second guide 22 in the longitudinal direction X of the first guide 21 and may align with the second guide 22 in the longitudinal direction X of the first guide 21.

The overlap area O of the second guide 22 overlaps the third guide 23 in the longitudinal direction X of the second guide 22 and may align with by the third guide 23 in the longitudinal direction X of the second guide 22.

As shown in FIG. 6, the non-overlap area N may be an area that does not overlap with another adjacent guide in the longitudinal direction X of the guide.

The non-overlap area N of the first guide 21 may not overlap the second guide 22 in the longitudinal direction X of the first guide 21.

The non-overlap area N of the second guide 22 may not overlap the third guide 23 in the longitudinal direction X of the second guide 22.

The first guide 21 may comprise a non-overlap area N and an overlap area O.

The second guide 23 may comprise a pair of overlap areas O and a non-overlap area N located between the pair of overlap areas O. One of the pair of overlap areas O may overlap the overlap area O of the first guide 21, and the other of the pair of overlap areas O may overlap the overlap area O of the third guide 23.

The third guide 23 may comprise an overlap area O and a non-overlap area N.

If each of the plurality of guides 2 comprises an overlap area O and a non-overlap area N, the plurality of guides 2 can move sequentially in the order disposed on the rail body 1, and entanglement of the charging cable 3 can be minimized.

An electromagnet 6 (refer to FIG. 8) may be disposed in each of the plurality of guides 2. An electromagnet receiving portion 28 in which the electromagnet 6 is accommodated may be formed inside the guide 2.

The control unit 52 can control a plurality of electromagnets 6.

The control unit 52 may control the electromagnet 6 by outputting a control signal to the switch unit 47 (refer to FIG. 3). The control unit 52 may independently control the plurality of electromagnets 6 and independently move the plurality of guides 2.

The control unit 52 may control the adjacent electromagnets 6 to have the same polarity or to have opposite or varying polarity. The control unit 52 may control the switch unit 47 to change adjacent electromagnets 6 to have the same polarity or to have varying or opposite polarity.

Controlling adjacent electromagnets 6 to the same polarity may mean controlling each of the adjacent electromagnets 6 so that the areas facing each other among the adjacent electromagnets 6 have the same polarity (N-N or S-S).

Controlling adjacent electromagnets 6 to opposite polarities may mean controlling each of the adjacent electromagnets 6 so that the areas facing each other among the adjacent electromagnets 6 have opposite polarities (N-S or S-N).

The guide 2 may comprise a base 24 and a supporter 26.

The base 24 may be guided along the rail body 1 in the longitudinal direction X of the rail body 1, and the guide 2 may be a linear moving guide.

If the charging cable 3 is suspended on the supporter 26, the supporter 26 may support the suspended portion of the charging cable 3.

The supporter 26 may protrude downward from the bottom of the base 24. The supporter 26 may have a ring shape, as shown in FIG. 7. The supporter 26 may have an opening 27 through which the charging cable 3 can pass. The opening 27 may be opened in a horizontal direction on either the left or right side of the supporter 26. The opening 27 may be opened in the left and right direction Y on either the left or right side of the supporter 26. The charging cable 3 can be inserted through the opening 27 at the side of the supporter 26 and suspended in the supporter 26.

The opening directions of the openings 27 of the supporters 26 of the plurality of guides 2 may be alternatingly opposite to each other.

For example, if the opening 27 formed in the supporter 26 of the first guide 21 is formed on the left side of the supporter 26, the opening 27 formed in the supporter 26 of the second guide 22 is formed on the right side of the supporter 26, and the opening 27 formed on the supporter 26 of the third guide 23 may be formed on the left side of the supporter 26.

Conversely, if the opening 27 formed in the supporter 26 of the first guide 21 is formed on the right side of the supporter 26, the opening 27 formed in the supporter 26 of the second guide 22 may be formed on the left side of the supporter 26, and the opening 27 formed in the supporter 26 of the third guide 23 may be formed on the right side of the supporter 26.

If the opening 27 formed in the supporter 26 of a guide 2 is opened toward an opposite direction with respect to a direction of an opening 27 in an adjacent guide 2, the charging cable 3 may be reliably mounted on the plurality of guides 2.

The supports 26 of the plurality of guides 2 may be parallel to each other.

The overlap area O may correspond to the area of the base 24, while the area of the supporters 26 of the plurality of guides 2 may not overlap, and in this case, entanglement of the charging cable 3 can be minimized.

The charger may comprise a guide communication module (7) disposed on the guide (2). A communication module receiving portion 29 in which the guide communication module 7 is accommodated may be formed inside the guide 2.

Examples of the communication module 7 may be a BLUETOOTH communication module, an ultrawide-band communication module, etc.

A user or an administrator may communicate with the guide communication module 7 through a mobile terminal external to the charger, and the guide communication module 7 may receive signals and other data from the mobile terminal.

The guide communication module 7 may communicate with the communication module provided in the coupler 31, and the electromagnet 6 provided in the guide 2 can be turned on or off according to the command received by the guide communication module 7.

The charger may further comprise a flat cable 8. The flat cable 8 may supply power to the electromagnet 6. The flat cable 8 may be elongated along the longitudinal direction X of the rail body 1. The flat cable 8 may be strip-shaped or plate-shaped. The flat cable 8 can be accommodated in the space of the beam.

The flat cable 8 may be placed between the rail body 1 and the guide 2. The flat cable 8 may be placed above or on the upper surface of the guide 2. The flat cable 8 may extend horizontally, particularly in the front and rear direction.

The flat cable 8 can apply current to the electromagnet 6 of the guide 2 while being fixed to the rail body 1.

The charger may further comprise bearings, including for example balls 9.

The ball 9 may be placed on the upper surface of the guide 2. The ball 9 can be brought into contact with the flat cable 8. A ball receiving portion 24a in which a portion of the ball 9 is accommodated may be formed on the upper surface of the guide 2. The ball 9 can roll when the guide 2 moves.

A plurality of balls 9 may be placed in the charger, and the guide 2 may slide smoothly on the rail body 1 via the balls 9.

An example of the guide 2 may be provided with an electrical contact point electrically connected to the electromagnet 6, and the electrical contact point may be in contact with the flat cable 8. Even if the guide 2 slides along the rail body 1, the electrical contact point may remain in contact with the flat cable 8 and apply a current to the electromagnet 6.

Another example of the guide 2 may comprise a wire electrically connected to the electromagnet 6, and the wire may be connected to the flat cable 8. Even if the guide 2 slides along the rail body 1, the wire can remain connected to the flat cable 8, and current can be applied to the electromagnet 6.

The other example of the guide 2 may comprise a ball 9 electrically connected to the electromagnet 6, and the ball 9 may be in contact with the flat cable 8. Even if the guide 2 slides along the rail body 1, the ball 9 can remain in contact with the flat cable 8 and apply a current to the electromagnet 6.

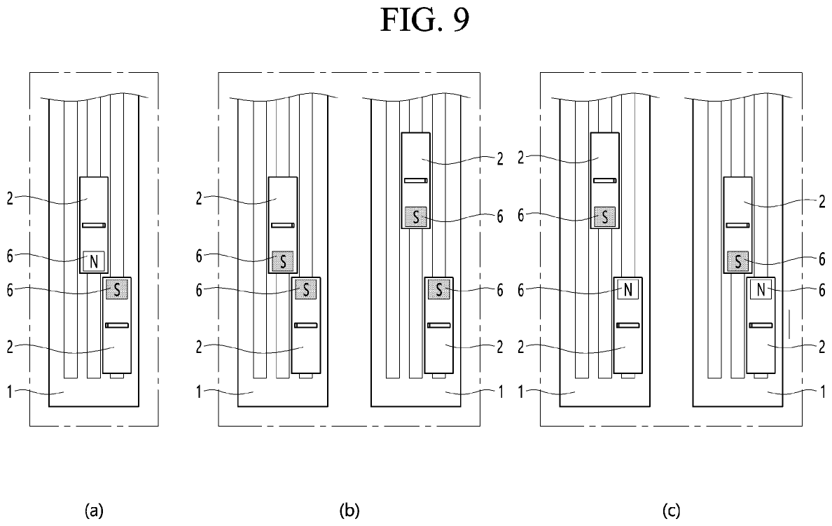

FIG. 9 is a view illustrating various modes of the charger according to an embodiment.

The control unit 52 may perform a locking mode (e.g., refer to (a) of FIG. 9). The locking mode can be performed in an initial state of the charger.

During the locking mode, the control unit 52 may control the plurality of electromagnets 6 to maintain the plurality of guides 2 to be positioned close to each other, as shown in (a) of FIG. 9.

The locking mode may be performed while the coupler 31 is maintained in the holster 50.

The coupler sensor 51 may transmit a cable maintenance signal to the control unit 52 while the coupler 31 is maintained in the holster 50. While the cable maintenance signal is input, the control unit 52 may control the electromagnets 6 of the two adjacent guides 2 to have opposite polarities, and the two adjacent guides 2 can maintain a state close to each other.

The control unit 52 may perform a withdrawn or pull-out mode (refer to (b) of FIG. 9). The pull-out mode may be referred to as a cable-out mode.

During the pull-out mode, the control unit 52 may control the plurality of electromagnets 6 so that the plurality of guides 2 are spaced apart from each other, as shown in (b) of FIG. 9.

The pull-out mode may be initiated if the coupler sensor 51 detects separation of the coupler 31 from the holster 50.

Separation of the coupler 31 from the holster 50 may be detected by the coupler sensor 51 which may transmit a cable separation signal to the control unit 52. If the cable separation signal is received, the control unit 52 can control the electromagnets 6 of the two adjacent guides 2 to have the same polarity, and the two adjacent guides 2 may be spaced apart from each other.

The control unit 52 may perform the pull-in mode (refer to (c) of FIG. 9). The pull-in mode may be referred to as a cable-in mode.

During the pull-in mode, the control unit 52 may control the plurality of electromagnets 6 so that the plurality of guides 2 are closer to each other, as shown in (c) of FIG. 9.

The pull-in mode may be initiated if the charging cable 3 is disconnected from the electric vehicle. The coupler 31 may communicate with the electric vehicle through PLC communication, etc., and when the coupler 31 is separated from the electric vehicle, the control unit 52 may control the electromagnets 6 of the two adjacent guides 2 to have the opposite polarity. The two adjacent guides (2) may then again be positioned closer to each other, as shown in (c) of FIG. 9.

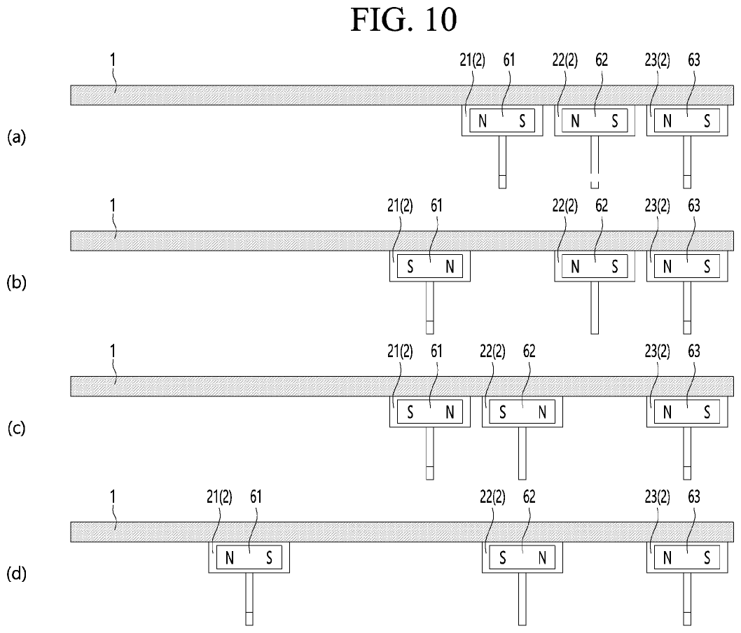

FIG. 10 is a view showing the pull-out mode of the charger according to an embodiment of the present disclosure.

Hereinafter, for convenience of explanation, the electromagnet installed in the first guide 21 will be referred to as 61, the electromagnet installed in the second guide 22 will be referred to as 62, and the electromagnet installed in the third guide 23 will be referred to as 63.

The pull-out mode can be performed while the charger is in the locking mode, which is shown in (a) of FIG. 10.

The pull-out mode may include performing a first mode (refer to (b) of FIG. 10), a second mode (refer to (c) of FIG. 10), and a third mode (refer to (d) of FIG. 10).

The first mode may be initiated while the charger is in the locking mode.

During the first mode, the first electromagnet 61 and the second electromagnet 62 among the plurality of electromagnets 6 may be controlled to have the same polarity, resulting in repelling magnetic force between the first and second electromagnets 61, 62. When the first electromagnet 61 and the second electromagnet 62 are controlled to have the same polarity, the first guide 21 and the second guide 22 can move away from each other, as shown in (b) of FIG. 10.

During the first mode, the control unit 52 may control the second electromagnet 62 and the third electromagnet 63 to have opposite polarities, or may not apply current to the third electromagnet 63.

During the first mode, the first guide 21 can be moved along the rail body 1, as shown in (b) of FIG. 10, and the first guide 21 and the second guide 22 may be spaced apart from each other.

The second mode may be performed after the first mode. During the second mode, the first electromagnet 61 and the second electromagnet 62 may be controlled to have opposite polarities. When the first electromagnet 61 and the second electromagnet 62 are controlled to have opposite polarities, the first guide 21 and the second guide 22 may be moved toward each other due to attractive magnetic force between the first and second electromagnets 61, 62.

During the second mode, the control unit 52 may control the second electromagnet 62 and the third electromagnet 63 to have the same polarity.

As a result, during the second mode, the second guide 22 may be moved along the rail body 1, as shown in (c) of FIG. 10, such that the second guide 22 and the first guide 21 may be positioned close to each other, and the second guide 22 may be spaced apart from the third guide 23.

The third mode may be performed after the second mode, and during the third mode, the first electromagnet 61 and the second electromagnet 62 may be controlled to have the same polarity. When the first electromagnet 61 and the second electromagnet 62 are controlled to have the same polarity, the first guide 21 and the second guide 22 may move away from each other.

During the third mode, the control unit 52 may control the second electromagnet 62 and the third electromagnet 63 among the plurality of electromagnets 6 to have the same polarity.

During the third mode, the first guide 21 can be moved along the rail body 1, as shown in (d) of FIG. 10, and the first guide 21 and the second guide 22 may be spaced apart from each other.

As shown in (d) of FIG. 10, when the first guide 21, the second guide 22, and the third guide 23 are deployed, each of the first guide 21, the second guide 22, and the third guide (23) can be spaced apart from other adjacent guides by a set distance or more.

The pull-in mode may proceed in the reverse order of the pull-out mode. During the pull-in mode, the charger can sequentially perform the third mode, the second mode, and the first mode to position the first, second, and third guides 21, 22, 23 as shown in (a) of FIG. 10, and the charger can then perform the locking mode.

The control unit 52 may generate a cable out signal that controls a plurality of electromagnets, e.g., 61, 62, 63 so that the plurality of guides 21, 22 and 23 are moved away from each other, based on the coupler 31 of the charging cable 3 being separated from the main body 4. The plurality of guides 21, 22, and 23 may be moved as shown in FIG. 2, and the cable 3 connected to the main body 4 may be extended.

Thereafter, the control unit 52 may generate a first cable stop signal if the coupler 31 of the charging cable 3 is connected to the electric vehicle, and movement of the plurality of guides 21, 22, and 23 may be stopped. The charging cable 3 may not be extended any further while the coupler 31 is connected to the electric vehicle.

An example of the first cable stop signal may be a signal that turns off the plurality of electromagnets 61, 62, and 63.

Thereafter, the control unit 52 can generate a cable-in signal that controls a plurality of electromagnets 61, 62, 63 such that the plurality of guides 21, 22, and 23 are positioned closer to each other, based on detecting that the coupler 31 of the charging cable 3 is separated from the electric vehicle. The plurality of guides 21, 22, and 23 can be moved as shown in FIG. 1, and the cable 3 connected to the main body 4 may be positioned closer to the main body (4).

Thereafter, the control unit 52 may generate a second cable stop signal, based on detecting that the coupler 31 of the charging cable 3 is mounted on the main body 4, and movement of the plurality of guides 21, 22, and 23 may be stopped. The charging cable 3 can be maintained as close to the main body 4 as possible while connected to the main body 4.

The second cable stop signal may be the same or different from the first cable stop signal.

An example of the second cable stop signal may be a signal that turns off the plurality of electromagnets 61, 62, and 63. Another example of the second cable stop signal may be a signal that controls a plurality of electromagnets 61, 62, and 63 so that the electromagnets 61, 62, and 63 attract each other.

In an embodiment of a control method of the charger, a cable-out step; a first stop step; a cable-in step; and a second stop step may be performed. The cable out step; the first stop step; the cable-in step; and the second stop step may be performed sequentially.

The cable out step may be initiated if the coupler 31 of the charging cable 3 is separated from the body 4. When the cable out step is initiated, the control unit 52 may generate a cable out signal to control the plurality of electromagnets 61, 62, and 63 so that the plurality of guides 21, 22, and 23 are spaced apart from each other.

The first stop step can be initiated if the coupler 31 of the charging cable 3 is connected to the electric vehicle, and the cable out step can be ended. When the first stop step is initiated, the control unit 52 may generate a first cable stop signal. An example of the first cable stop signal may be a signal that turns off the plurality of electromagnets 61, 62, and 63.

The cable in step can be initiated once the coupler 31 of the charging cable 3 is disconnected from the electric vehicle. When the cable-in step is initiated, the control unit 52 may generate a cable-in signal to control the plurality of electromagnets 61, 62, and 63 so that the plurality of guides 21, 22, and 23 are positioned closer to each other.

The second stop step can be initiated when the coupler 31 of the charging cable 3 is mounted on the main body 4, and the cable in step can be ended. When the second stop step is initiated, a second cable stop signal may be generated. An example of the second cable stop signal is a signal that turns off the plurality of electromagnets 61, 62 and 63 or a plurality of electromagnets 61 and 62 so that the plurality of electromagnets 61, 62 and 63 attract each other. It may be a signal that controls 63.

According to embodiments of the present disclosure, as the guide on which the charging cable is mounted is moved and extends along the rail body, the force with which the user is required to pull the charging cable can be minimized.

In addition, as the guide on which the charging cable is mounted moves along the rail body to gather the charging cable, the force required by the user to return the charging cable can be minimized, and the charging cable can be returned to an original position with high reliability.

In addition, in an embodiment each of the plurality of guides may comprise an overlap area, thus ensuring that the positioning order of the plurality of guides does not change thereby reducing any twisting of the charging cable.

In addition, since the supporter of a guide does not overlap with the supporter of an adjacent guide, twisting of the charging cable can be minimized.

In addition, when the user disconnects the charging cable from the holster, a pull-out mode may be initiated, thus requiring no separate operation to start the pull-out mode, increasing convenience of use.

In addition, when the user disconnects the charging cable from the electric vehicle, a pull-in mode may be initiated, thus requiring no separate operation to start the pull-in mode, increasing convenience of use.

The above description is merely an example of the technical idea of the present invention, and various modifications and variations can be made to those skilled in the art without departing from the essential characteristics of the present invention.

Therefore, the embodiments disclosed in the present invention are not intended to limit the technical idea of the present invention, but to explain, and the scope of the technical idea of the present invention is not limited by these embodiments.

The protection scope of the present invention should be construed according to the claims below, and all technical ideas within the equivalent range should be construed as being comprised in the scope of the present invention.

What is claimed:

1. A charger comprising:
a rail body on which a plurality of rails is formed;
a plurality of guides correspondingly and slidably arranged on the plurality of rails and configured to support a charging cable of the charger;
a plurality of electromagnets correspondingly disposed on the plurality of guides; and
a control unit configured to control a position of the charging cable by operation of the plurality of electromagnets.

2. The charger according to claim 1,
wherein a first guide of the plurality of guides is disposed such that an overlap area of the first guide overlaps an overlap area of an adjacent second guide with respect to a longitudinal direction of the rail body.

3. The charger according to claim 2,
wherein each guide comprises:
a base; and
a supporter formed at a bottom of the base and on which the charging cable is suspended.

4. The charger according to claim 3,
wherein the overlap area of the first guide corresponds to the base of the first guide, and an area of the first guide corresponding to the supporter does not overlap with an area of a supporter of the second guide.

5. The charger according to claim 1, further comprising:
a guide communication module disposed at each guide,
wherein a receiving portion is formed inside the guide to accommodate the guide communication module therein.

6. The charger according to claim 1, further comprising:
a flat cable disposed between the rail body and each guide and configured to supply power to the plurality of electromagnets.

7. The charger according to claim 6, further comprising:
a plurality of balls disposed between an upper surface of each guide and the flat cable.

8. The charger according to claim 1,
wherein the control unit is configured to perform a cable pull-out mode by controlling the plurality of electromagnets such that the plurality of guides are moved away from each other.

9. The charger according to claim 8, further comprising:
a main body to which the charging cable is connected,
wherein the main body comprises:
a holster providing a mount for a coupler of the charging cable; and
a coupler sensor installed at the holster to detect mounting of the coupler.

10. The charger according to claim 9,
wherein the main body comprises a coupler holder rotatably or slidably disposed in the holster.

11. The charger according to claim 8,
wherein performing the cable pull-out mode comprises:
performing a first mode in which the first and the second electromagnets are operated to have a same polarity; and
performing, after the first mode, a second mode in which the first and the second electromagnets are operated to have opposite polarities.

12. The charger according to claim 11,
wherein the control unit is configured to operate the second and the third electromagnets to have a same polarity during the second mode.

13. The charger according to claim 11,
wherein performing the cable pull-out mode further comprises:
performing, after the second mode, a third mode in which the first and the second electromagnets are operated to have a same polarity.

14. The charger according to claim 13,
wherein the control unit is configured to operate the second and the third electromagnets to have a same polarity during third mode.

15. The charger according to claim 1,
wherein the control unit is configured to perform a cable pull-in mode by controlling the plurality of electromagnets such that the plurality of guides are moved closer to each other.

16. The charger according to claim 15,
wherein the cable pull-in mode is initiated based on detecting that the charging cable is disconnected from an electric vehicle being charged by the charger.

17. The charger according to claim 1,
wherein the control unit is configured to perform a cable locking mode by controlling the plurality of electromagnets such that positions of the plurality of guides are maintained close to each other.

18. The charger according to claim 1, further comprising:
a main body to which the charging cable is connected,
wherein the control unit is configured to:
generate a cable-out signal to cause operation of the plurality of electromagnets such that the plurality of guides are moved away from each other based on detecting separation of a coupler of the charging cable from the main body;
generate a first cable stop signal based on detecting that the coupler of the charging cable is connected to an electric vehicle;
generate a cable-in signal to cause operation of the plurality of electromagnets such that the plurality of guides are moved closer to each other based on detecting separation of the coupler of the charging cable from the electric vehicle; and
generate a second cable stop signal based on detecting that the coupler of the charging cable is mounted on the main body.

19. A control method of a charger having a plurality of guides slidably arranged on a plurality of rails for supporting a charging cable of the charger, the method comprising:
generating a cable-out signal to cause operation of a plurality of electromagnets correspondingly disposed in the plurality of guides such that the plurality of guides are moved away from each other based on detecting that a coupler of the charging cable is separated from a main body of the charger;
generating a first cable stop signal based on detecting that the coupler of the charging cable is connected to an electric vehicle;
generating a cable-in signal to cause operation of the plurality of electromagnets such that the plurality of guides are moved closer to each other based on detecting separation of the coupler of the charging cable from the electric vehicle; and
generating a second cable stop signal based on detecting that the coupler of the charging cable is mounted on the main body.
